(19) United States
(12) Patent Application Publication
(10) Pub. No.: US 2017/0337669 A1
(43) Pub. Date: Nov. 23, 2017

(54) IMAGE PROCESSING DEVICE, IMAGE PROCESSING METHOD, AND PROGRAM

(71) Applicant: SONY CORPORATION, TOKYO (JP)

(72) Inventors: TAKURO KAWAI, TOKYO (JP); TAKAHIRO NAGANO, KANAGAWA (JP)

(21) Appl. No.: 15/534,148

(22) PCT Filed: Sep. 28, 2015
(86) PCT No.: PCT/JP2015/077342

§ 371 Date: Jun. 8, 2017

(30) Foreign Application Priority Data
Dec. 24, 2014 (JP) 2014-260883

(51) Int. Cl. G06T 5/00; H04N 5/243; H04N 5/33; G06T 5/20; B60R 1/00

(52) U.S. Cl. CPC G06T 5/009; H04N 5/33; G06T 5/20; H04N 5/243; B60R 2300/307; B60R 1/00; G06T 2207/20208; G06T 2207/10048

(57) ABSTRACT

[Object] To provide stable infrared images. [Solution] Provided is an image processing device including: an acquisition unit that acquires an infrared image; and a control unit that variably controls a target wavelength of the infrared image acquired by the acquisition unit and controls gradation of the infrared image depending on the target wavelength.

### TECHNICAL FIELD

The present invention relates to an image processing device, an image processing method, and a program.

### BACKGROUND ART

In the related art, images captured by infrared cameras have been used for drive assist and other purposes. In particular, relatively clear images can be obtained by using near infrared rays or short wavelength infrared rays to capture images even under poor conditions such as at night or during bad weather. In general, images of near infrared rays or short wavelength infrared rays are captured by receiving reflected light from infrared rays emitted from a camera (see Patent Literature 1, for example).

### CITATION LIST

### Patent Literature

Patent Literature 1: JP 2009-130709A

### DISCLOSURE OF INVENTION

### Technical Problem

In general, there is a need to provide stable images that are not affected by disturbance for the purpose of representing infrared images to a user or executing recognition processing such as person recognition or object recognition on the basis of infrared images.

Thus, the present disclosure proposes a novel and improved image processing device, an image processing method, and a program capable of providing stable infrared images.

### Solution to Problem

According to the present disclosure, there is provided an image processing device including: an acquisition unit that acquires an infrared image; and a control unit that variably controls a target wavelength of the infrared image acquired by the acquisition unit and controls gradation of the infrared image depending on the target wavelength.

According to the present disclosure, there is provided an image processing method including: acquiring an infrared image by an image processing device; variably controlling a target wavelength of the acquired infrared image; and controlling gradation of the infrared image depending on the target wavelength.

According to the present disclosure, there is provided a program causing a computer that controls an image processing device to function as: an acquisition unit that acquires an infrared image; and a control unit that variably controls a target wavelength of the infrared image acquired by the acquisition unit and controls gradation of the infrared image depending on the target wavelength.

### Advantageous Effects of Invention

According to the present disclosure, it is possible to provide stable infrared images as described above.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating various purposes of infrared (IR) images that depend on wavelengths.

FIG. 2 is an explanatory diagram illustrating a specific example of an infrared image obtained by using infrared rays with a specific wavelength.

FIG. 3 is an explanatory diagram illustrating a specific example of an infrared image obtained by using infrared rays with a wavelength that is different from that in the example of FIG. 2.

FIG. 4 is an explanatory diagram illustrating a specific example of a hardware configuration of an image processing device according to an embodiment of the present disclosure.

FIG. 5 is an explanatory diagram illustrating a specific example of a logical functional configuration of the image processing device according to the embodiment of the present disclosure.

FIG. 6 is an explanatory diagram illustrating a specific example of switching of a target wavelength of emitted infrared rays.

FIG. 7 is an explanatory diagram illustrating a specific example of the switching of the target wavelength of the emitted infrared rays.

FIG. 8 is an explanatory diagram illustrating a specific example of a filter coefficient table for a filter coefficient determined in advance for each of a plurality of wavelength candidates.

FIG. 9 is an explanatory diagram illustrating a specific example of a filter coefficient table for a filter coefficient determined in advance for each of combinations of the plurality of wavelength candidates and reference wavelengths.

FIG. 10 is an explanatory diagram illustrating a specific example of filter taps of a filter used in filter computation performed by a conversion unit.

FIG. 11 is a flowchart illustrating a specific example of a flow of processing performed by the image processing device according to the embodiment of the present disclosure.

FIG. 12 is a flowchart illustrating a specific example of a flow of pixel value conversion processing performed by the image processing device according to the embodiment of the present disclosure.

FIG. 13 is a flowchart illustrating a specific example of a flow of processing performed by an image processing device according to a first modification example.

FIG. 14 is a flowchart illustrating a specific example of a flow of pixel value conversion processing performed by an image processing device according to a second modification example.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Description will be given in the following order.
1. Introduction
2. Image processing device according to embodiment of present disclosure
2-1. Hardware configuration
2-2. Functional configuration
2-3. Operations
2-3. Modification examples
3. Conclusion

### 1. INTRODUCTION

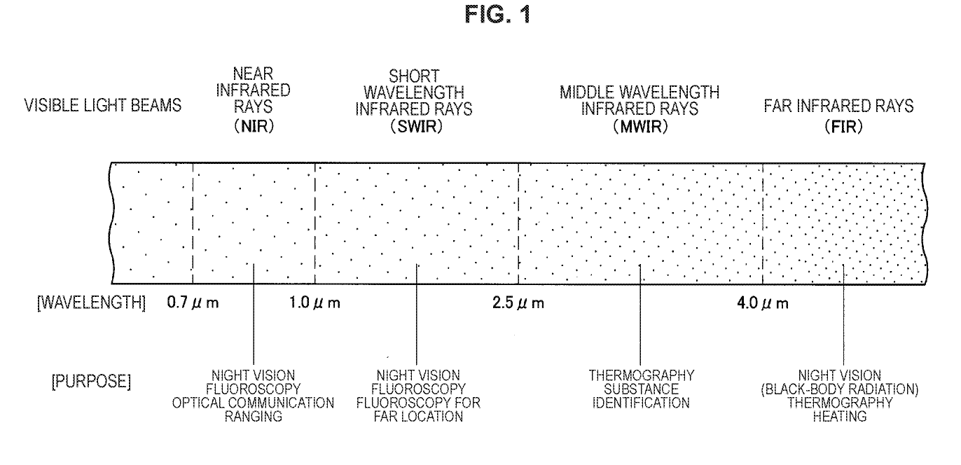

FIG. 1 is an explanatory diagram illustrating various purposes of infrared (IR) images depending on wavelengths. The horizontal direction in FIG. 1 corresponds to a wavelength of an infrared ray, and the wavelength increases from the left side to the right side. A light beam with a wavelength of equal to or less than 0.7 μm is a visible light beam, and human vision senses this visible light beam. An infrared ray with a wavelength within a range from 0.7 μm to 1.0 μm is classified into a near infrared ray (NIR). The near infrared ray can be used for night vision, fluoroscopy, optical communication, and ranging. An infrared ray with a wavelength within a range from 1.0 μm to 2.5 μm is classified into a short wavelength infrared ray (SWIR). The short wavelength infrared ray can also be used for night vision and fluoroscopy. A night vision device that uses a near infrared ray or a short wavelength infrared ray emits an infrared ray to the vicinity first, and receives reflected light thereof, thereby obtaining an infrared image. An infrared ray with a wavelength within a range from 2.5 μm to 4.0 μm is classified into a middle wavelength infrared ray (MWIR). Since an absorption spectrum unique to a substance appears within the wavelength range of the middle wavelength infrared ray, the middle wavelength infrared ray can be used for identifying substances. The middle wavelength infrared ray can also be used for thermography. An infrared ray with a wavelength of equal to or greater than 4.0 μm is classified into a far infrared ray (FIR). The far infrared ray can be used for night vision, thermography, and heating. An infrared ray emitted by black-body radiation from a substance corresponds to the far infrared ray. Therefore, a night vision device that uses a far infrared ray can obtain an infrared image by capturing black-body radiation from a substance without emitting an infrared ray. The boundary values of the ranges of the wavelengths illustrated in FIG. 1 are only examples. There are various definitions for boundary values of classifying the infrared rays, and advantages of the technology according to the present disclosure, which will be described later, can be achieved under any definitions.

NIR and SWIR from among the various types of infrared rays exemplified in FIG. 1, in particular, are used for obtaining clear images under poor conditions such as at night or during a bad weather. One of representative purposes is vehicle equipment, and an NIR or SWIR image provide a supplemental view such as a night view, a back view, or a surrounding view to a driver. The NIR or SWIR image can also be used for recognizing a subject that can include objects such as pedestrians, road signs, or obstacles and presenting drive assist information to the driver. In general, an infrared camera that captures the NIR or SWIR image emits an infrared ray to the vicinity at the time of imaging as described above.

However, in a scene in which a plurality of infrared cameras captures images at the same time, an infrared ray emitted from a certain camera may be disturbance for images captured by the other cameras. When two facing vehicles capture infrared images with the same target wavelength at the same time, for example, there is a risk that light emitted from the counterpart vehicle is strongly captured in the captured image and it becomes difficult to distinguish surrounding objects to be originally captured in the image. Patent Literature 1 proposes restricting the infrared rays emitted from the infrared cameras of the individual vehicles and polarization directions of the infrared rays received by the cameras to specific directions in order to eliminate such a risk. However, only the restriction of the polarization directions can merely avoid competition of image capturing by only about 3 cameras (for example, polarization in a longitudinal direction, a lateral direction, and an oblique direction) in practice.

Thus, a method of causing these infrared cameras to use mutually different target wavelength has been considered in order to avoid the competition of the image capturing in the scene where more infrared cameras capture images at the same time. The wavelength region of the infrared ray that belongs to NIR or SWIR can be divided into at least ten or more types of target wavelengths though depending on configurations of the imaging devices. Therefore, it is possible to capture images in a parallel manner without causing the more infrared cameras to compete with each other in the case of the separation based on the target wavelength as compared with the case of the separation based on the polarization directions. Such a method is also useful in a scene where infrared images are captured by a smart phone in a crowd as well as the image capturing by the vehicle equipment on a busy road on which a number of vehicles travel.

On the assumption that the plurality of infrared cameras also move, it becomes necessary to dynamically switch the target wavelengths of the individual cameras over time in order to appropriately separate the infrared cameras. When the target wavelengths are then switched, unnatural changes may occur in the gradation (the magnitude of the pixel values that express shade or a color tone, for example) of the infrared images before and after the switching.

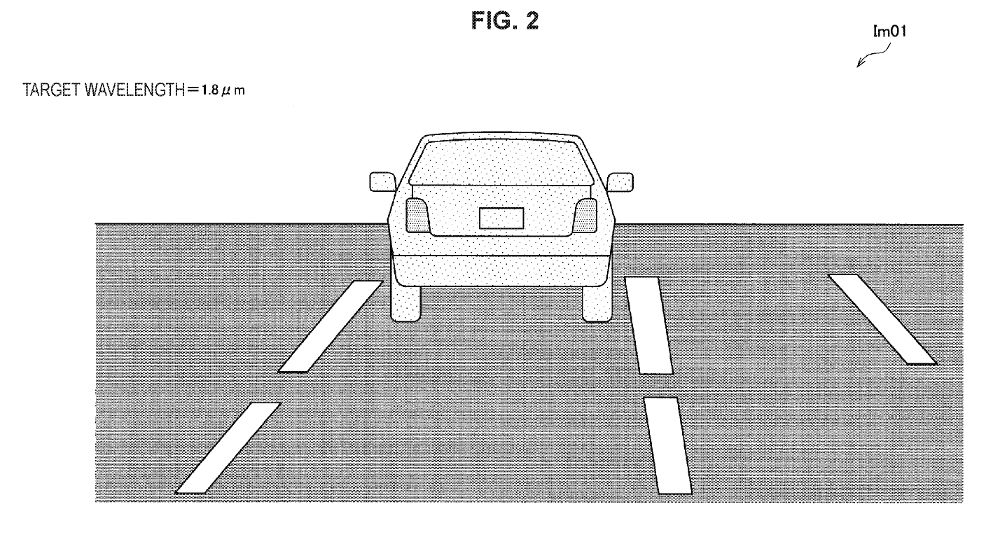

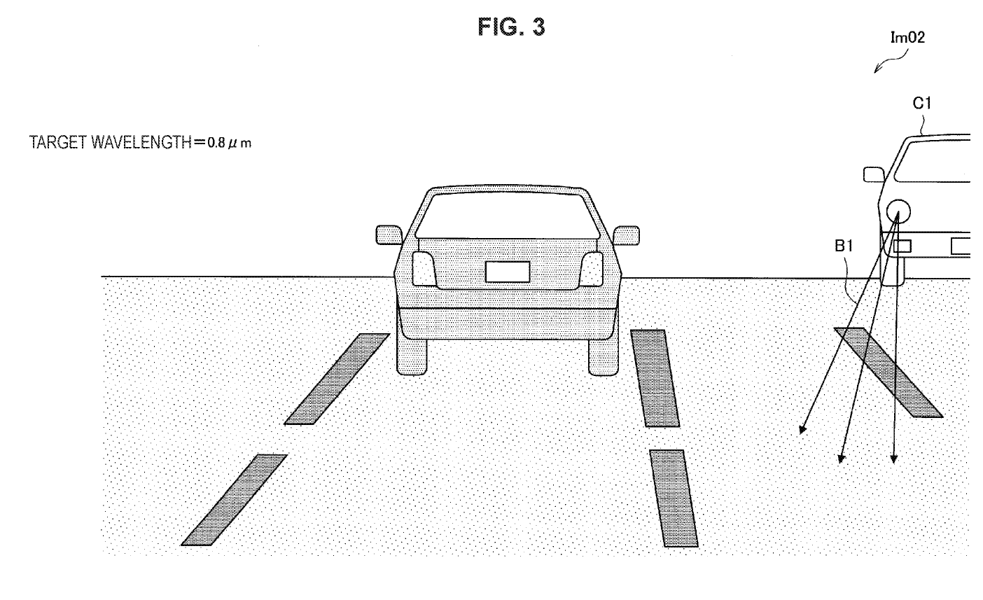

FIGS. 2 and 3 are explanatory diagrams illustrating specific examples of infrared images obtained by using infrared rays with mutually different wavelengths. In FIGS. 2 and 3, differences in the patterns applied to the respective sections represent differences in pixel values. The infrared image Im01 illustrated in FIG. 2 is obtained by imaging a front side of a vehicle traveling on a road by an infrared camera provided in the vehicle. The target wavelength of the infrared image Im01 is 1.8 μm. A case where an oncoming car C1 that captures images by using an infrared ray with a wavelength of 1.8 μm that is the same as the aforementioned target wavelength then enters an angle of view of the aforementioned infrared camera can be assumed as illustrated in FIG. 3. In such a case, it is possible to suppress emitted light B1 emitted by the oncoming car C1 from being strongly captured in the infrared image that is obtained by image capturing performed by the aforementioned infrared camera, by switching the target wavelength of the aforementioned infrared camera. In one example, the target wavelength of the infrared image Im01 illustrated in FIG. 3 is 0.8 μm. The light B1 with the wavelength of 1.8 μm emitted from the oncoming car C1 is not strongly captured in the infrared image Im02. However, as can be understood from the comparison between FIGS. 2 and 3, an unnatural change has occurred in the gradation of the infrared image before and after the switching of the target wavelength of the aforementioned infrared camera. Such an unexpected change in the gradation also damages stability of images and adversely affects visual recognition of an object by a user or recognition of a person or an object in the following recognition processing. Thus, a mechanism capable of providing more stable infrared images will be proposed in the specification.

### 2. IMAGE PROCESSING DEVICE ACCORDING TO EMBODIMENT OF PRESENT DISCLOSURE

### 2-1. HARDWARE CONFIGURATION

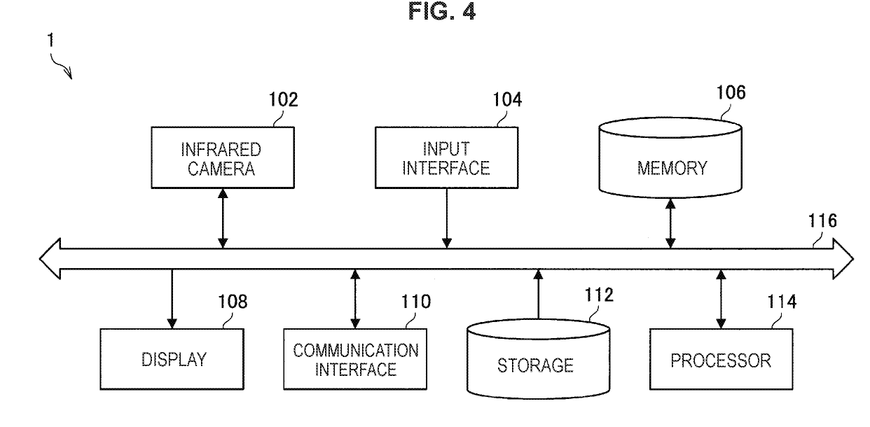

First, a hardware configuration example of an image processing device 1 according to an embodiment of the present disclosure will be described. FIG. 4 is an explanatory diagram illustrating a specific example of a hardware configuration of the image processing device 1 according to the embodiment of the present disclosure. As illustrated in FIG. 4, the image processing device 1 includes an infrared camera 102, an input interface 104, a memory 106, a display 108, a communication interface 110, a storage 112, a processor 114, and a bus 116.

### (Infrared Camera)

The infrared camera 102 is an imaging module that captures images by using an infrared ray and obtains original images. The infrared camera 102 has alignment of imaging elements that sense the infrared ray and light emitting elements that emit the infrared ray to the vicinity of the device. For example, the infrared camera 102 obtains original images by emitting the infrared ray from the light emitting elements in response to a trigger such as a user input or in a periodical manner and receiving the infrared ray reflected by an object or a background thereof. A series of original images obtained by the infrared camera 102 forms a video image. The original images obtained by the infrared camera 102 may be images that have undergone preliminary processing such as signal amplification or noise removal.

For example, the infrared camera 102 may have an optical filter that causes only an infrared ray with a wavelength that belongs to a specific passing band to pass therethrough. In such a case, the imaging elements receive the infrared ray that has passed through the optical filter. In the example described later, the optical filter is a variable filter capable of variably controlling the passing band. The passing band of the variable filter can be changed by operating (rotating, moving, or the like) a substrate with a passing film that transmits light with different wavelength depending on sites thereof, for example. The infrared camera 102 can detect visible light in addition to the infrared ray. The light emitting elements emit an infrared ray in an irradiation band including a target wavelength. The irradiation band of the light emitting element is controlled by the control unit 152 which will be described later.

### (Input Interface)

The input interface 104 is used by a user to operate the image processing device 1 or input information to the image processing device 1. For example, the input interface 104 may include an input device such as a touch sensor, a keypad, a button, or a switch. The input interface 104 may include a microphone for sound input and sound recognition module. The input interface 104 may include a remote control module that receives commands selected by the user from a remote device.

### (Memory)

The memory 106 is a storage medium that can include a random access memory (RAM) and a read only memory (ROM). The memory 106 is coupled to the processor 114 and stores a program and data for processing executed by the processor 114.

### (Display)

The display 108 is a display module that has a screen for displaying images. For example, the display 108 may be a liquid crystal display (LCD) or an organic light-emitting diode (OLED).

### (Communication Interface)

The communication interface 110 is a module that relays communication between the image processing device 1 and other devices. The communication interface 110 establishes communication connection in accordance with an arbitrary wireless communication protocol or a wired communication protocol.

### (Storage)

The storage 112 is a storage device that accumulates image data that can include infrared images or stores a database that can be used in infrared image processing. The storage 112 embeds a storage medium such as a semiconductor memory or hard disk therein. The program and the data described in the specification may be acquired from a data source (a data server, a network storage, or an external memory, for example) outside the image processing device 1.

### (Processor)

The processor 114 is a processing module such as a central processing unit (CPU) or a digital signal processor (DSP). The processor 114 causes functions of providing more stable infrared images to be operated by executing the program stored in the memory 106 or another storage medium.

### (Bus)

The bus 116 connects the infrared camera 102, the input interface 104, the memory 106, the display 108, the communication interface 110, the storage 112, and the processor 114 to each other.

### 2-2. FUNCTIONAL CONFIGURATION

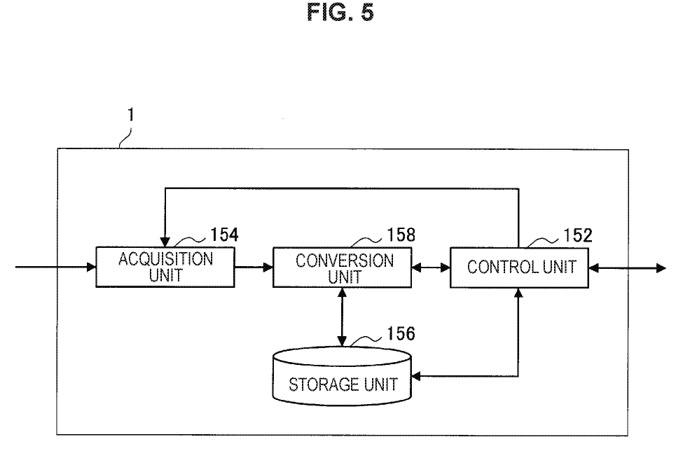

In the previous section, the hardware configuration of the image processing device 1 according to the embodiment of the present disclosure was described. Next, a logical functional configuration of the image processing device 1 according to the embodiment of the present disclosure will be described with reference to FIGS. 5 to 10.

FIG. 5 is a block diagram illustrating an example of the logical functional configuration that is realized by causing components of the image processing device 1 illustrated in FIG. 4 to work in conjunction with each other. As illustrated in FIG. 5, the image processing device 1 includes a control unit 152, an acquisition unit 154, a storage unit 156, and a conversion unit 158.

### (Control Unit)

The control unit 152 controls imaging, image processing, display, and recording of infrared image in the image processing device 1. For example, the control unit 152 causes the conversion unit 158 to convert gradation of an infrared image captured by the infrared camera 102, if necessary, and causes the display 108 to display the image with the stabilized gradation on the screen thereof. The control unit 152 may output the infrared image to processing in a later stage, which is not illustrated in the drawing, instead of (or in addition to) displaying the infrared image on the screen. The processing in the later stage described herein can include recognition processing for recognizing a person (a pedestrian or the like) or recognition of an object (another vehicle, a road sign, an obstacle, or the like) for the purpose of drive assist or provision of safety information. The control unit 152 may cause the storage unit 156 to store the image with the stabilized gradation.

In the embodiment, the control unit 152 variably controls the target wavelength of the infrared image to be acquired by the acquisition unit 154 in order to avoid the image becoming unstable due to the plurality of infrared cameras capturing images at the same time. The control unit 152 can recognize wavelengths of infrared rays used in the vicinity of the image processing device 1 on the basis of information received from other devices via the communication interface 110, for example. Other devices described herein may be other image processing devices (vehicle equipment, for example) that have separate infrared cameras, or may be management devices (road-side equipment, for example) that intensively manage imaging operations in a specific region, for example. The control unit 152 may recognize wavelengths of infrared rays used in the vicinity by analyzing the infrared images acquired by the acquisition unit 154. When the target wavelength set in the acquisition unit 154 coincides with a wavelength of an infrared ray used in the vicinity or is similar to a wavelength of an infrared ray used in the vicinity to such a degree that the infrared rays adversely affect each other, the control unit 152 switches the target wavelength of the infrared images to be acquired by the acquisition unit 154. Typically, the target wavelength can be selected from a plurality of wavelength candidates stored in advance in the storage unit 156.

In a first example, the variable control of the target wavelength of the infrared images is performed by the control unit 152 switching a passing band of an optical filter provided in the infrared camera 102. In the first example, the control unit 152 causes the substrate of the optical filter (variable filter) to operate such that the infrared ray with the target wavelength after the switching passes through the passing film of the filter and is incident on the imaging elements.

In a second example, the variable control of the target wavelength of the infrared images is performed by the control unit 152 causing the acquisition unit 154 to separate a component of the target wavelength from an original image obtained by imaging an object. In the second example, the original image is output from the alignment of the plurality of imaging elements that sense mutually different wavelength components (which may include not only infrared components but also visible light components). It is known that a plurality of wavelength components are mixed in the pixel values of such an original image as a result of the wavelength components affecting each other. Thus, the acquisition unit 154 separates the component of the target wavelength from the original image, in which a plurality of wavelength components are mixed, by demosaicking the original image and executing predetermined filter computation in response to an instruction from the control unit 152.

The first example and the second example may be combined. In such a case, the acquisition unit 154 separates the wavelength component of the target wavelength from the original image based on the infrared ray that has passed through the optical filter of the infrared camera 102. In this manner, it is possible to acquire the infrared image in which components of the wavelengths that are different from the target wavelength and correspond to disturbance are reduced.

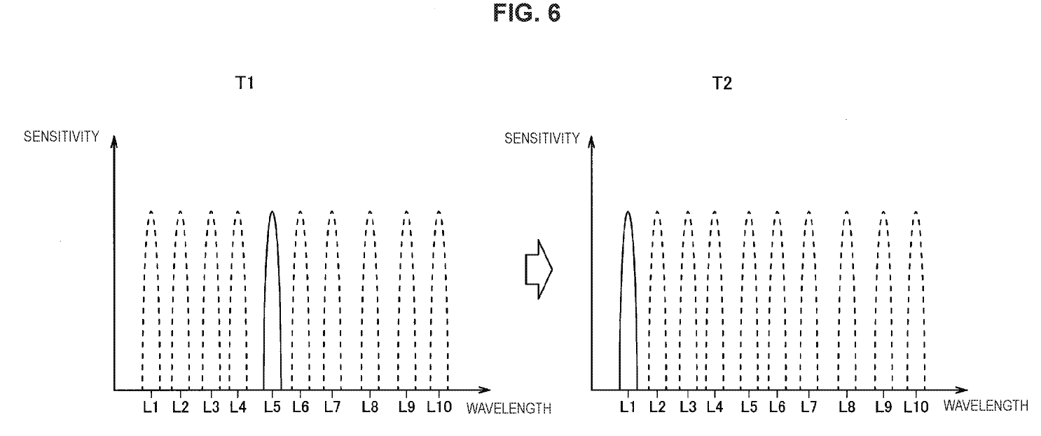

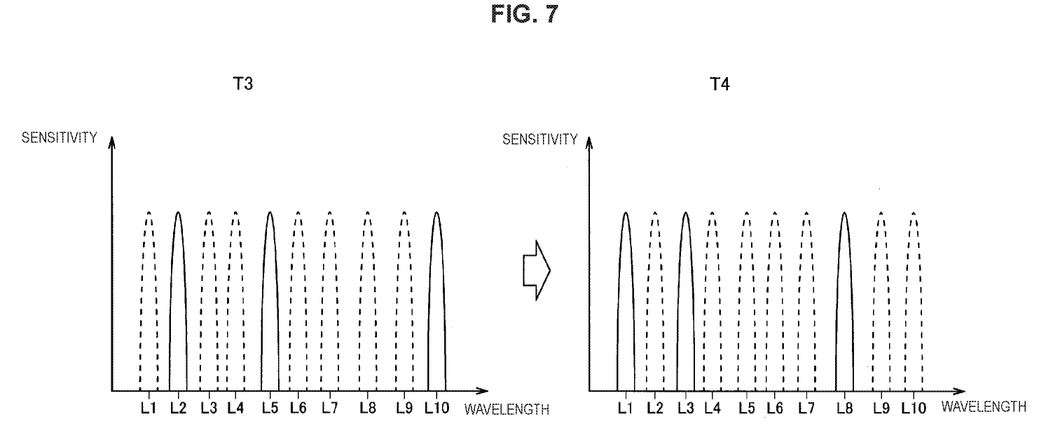

Furthermore, the control unit 152 controls emission of the infrared ray from the infrared camera 102 depending on setting of the target wavelength. Specifically, the control unit 152 causes the light emitting elements of the infrared camera 102 to emit an infrared ray in an irradiation band that includes a target wavelength that is set to be different from the wavelengths used in the vicinity. FIGS. 6 and 7 are explanatory diagrams illustrating specific examples of switching of target wavelengths of the emitted infrared rays. In the example of FIG. 6, the target wavelength is a single wavelength selected from ten wavelength candidates L1 to L10. For example, the target wavelength is the wavelength L5 at time T1, and the light emitting elements emit the infrared ray with the target wavelength L5. Even if the devices in the vicinity emit infrared rays with any wavelengths from L1 to L4 or L6 to L10 during a period from the time T1 to time T2, the infrared images acquired by the acquisition unit 154 are not affected by the emission. Thereafter, the target wavelength is changed to the wavelength L1 at the time T2. Even if the devices in the vicinity emit the infrared ray with the wavelength L5 during a specific period following the time T2, the infrared images acquired by the acquisition unit 154 are not affected by the emission.

The target wavelength is not limited to the examples in FIG. 6 and may include a plurality of wavelengths instead of the single wavelength. In the example of FIG. 7, target wavelengths are three wavelengths selected from ten wavelength candidates L1 to L10. For example, the target wavelengths are L2, L5, and L10 at time T3, and the plurality of light emitting elements respectively emit infrared rays with the target wavelengths L2, L5, and L10. Thereafter, the target wavelengths are changed to the wavelengths L1, L3, and L8 at time T4. The plurality of light emitting elements respectively emit infrared rays with the target wavelengths L1, L3, and L8 at the time T4. Instead of causing the plurality of light emitting element to emit the infrared rays with mutually different target wavelengths at the same time, each single light emitting element may sequentially emit the infrared rays with mutually different target wavelengths.

In the embodiment, the control unit 152 controls gradation of the infrared image depending on the target wavelength. Specifically, when the target wavelength is different from the reference wavelength, the control unit 152 controls the gradation of the infrared image so as to lessen a change in the gradation of the infrared image from an image acquired at the reference wavelength. For example, the control unit 152 controls the gradation of the infrared image by causing the conversion unit 158 to convert pixel values of the infrared image by using conversion control information depending on the target wavelength. The conversion of the pixel values of the infrared image performed by the conversion unit 158 will be described later in detail.

The reference wavelength may be defined in advance. The control unit 152 may dynamically set the reference wavelength. For example, a target wavelength when capturing of a series of images (that is, a video image) is started may be automatically set as the reference wavelength. The reference wavelength may be set by the user via a user interface. For example, the control unit 152 may provide the user interface for allowing the user to select the reference wavelength from a plurality of candidates of the reference wavelength stored in advance in the storage unit to the user via the input interface 104 and the display 108. The setting value of the reference wavelength is stored in the storage unit 156. Not only when the target wavelength is switched, but also when the reference wavelength is changed, the control unit 152 may adjust the gradation of the infrared image depending on the reference wavelength after the change.

### (Acquisition Unit)

The acquisition unit 154 acquires an infrared image and outputs the acquired infrared image to the conversion unit 158. In the aforementioned first example, the acquisition unit 154 acquires an original image, which has been obtained by the infrared camera 102, as the infrared image. The original image described herein is an image in which components with wavelengths other than the target wavelength have already been reduced sufficiently by the optical filter of the infrared camera 102. Since the passing band of the optical filter is switched to a band corresponding to a new target wavelength when the target wavelength is switched, the acquisition unit 154 can acquire an infrared image with the new target wavelength.

In the aforementioned second example, the acquisition unit 154 acquires the infrared image with the target wavelength by separating the component of the target wavelength from the original image obtained by the infrared camera 102. For example, the acquisition unit 154 separates the component of the target wavelength from the original image, in which a plurality of wavelength components are mixed, by demosaicking the original image obtained by the infrared camera 102 and executing predetermined filter computation. For example, a parameter of the filter computation can be determined in advance through learning processing.

The acquisition unit 154 may acquire an infrared image stored in the storage 112. The acquisition unit 154 may acquire an infrared image from another device via the communication interface 110. The infrared image acquired by the acquisition unit 154 may be an image that has undergone preliminary processing such as signal amplification and noise removal. The acquisition unit 154 may decode an infrared image from a coded stream compressed and encoded.

### (Storage Unit)

The storage unit 156 stores data to be referred to for the conversion of the pixel values of the infrared image performed by the conversion unit 158 and various kinds of control performed by the control unit 152.

For example, the storage unit 156 stores setting values of the target wavelength and the reference wavelength. The setting values of the target wavelength and the reference wavelength can be changed by the control unit 152. The storage unit 156 stores in advance a plurality of wavelength candidates that can be selected by the control unit 152 as the target wavelength or the reference wavelength.

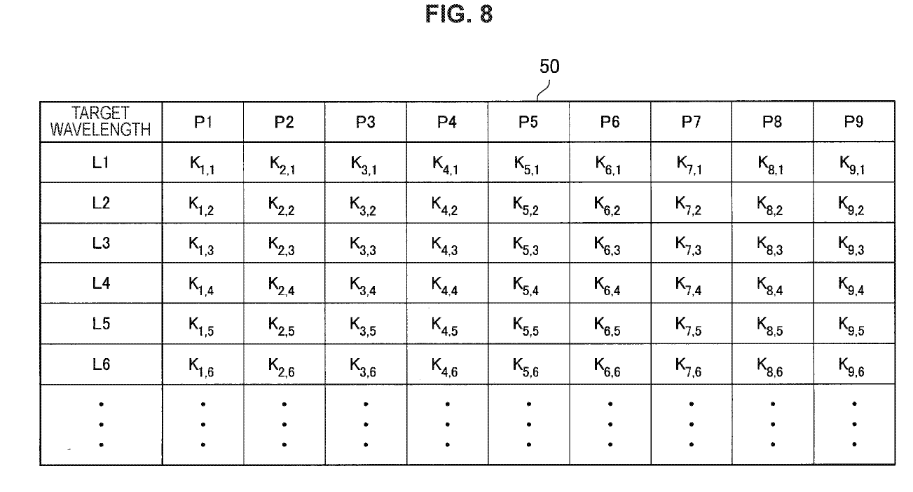

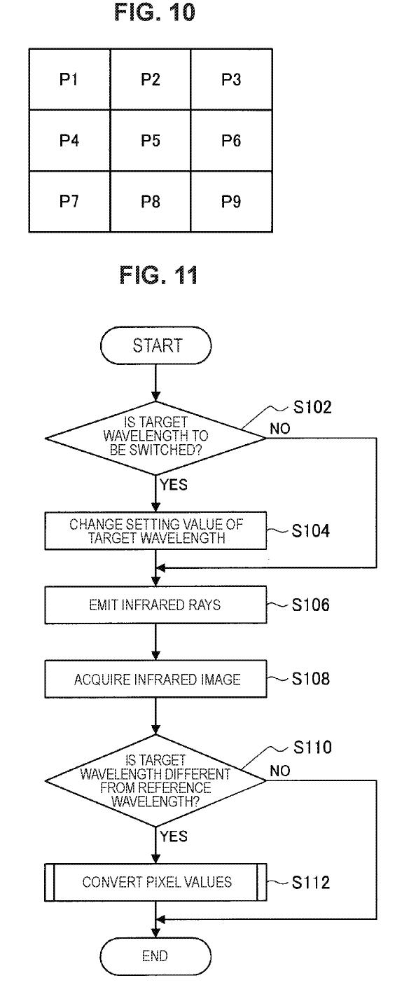

The data for converting the pixel values, which is stored in the storage unit 156, can include a filter coefficient that is determined in advance for each of the plurality of wavelength candidates of the target wavelength. FIG. 8 is an explanatory diagram illustrating a specific example of a filter coefficient table for the filter coefficient that is determined in advance for each of the plurality of wavelength candidates. The example in FIG. 8 is on the basis of the assumption that the filter for converting the pixel values is formed of spatial filter taps P1 to P9 with a 3×3 grid shape around a focused pixel P5 as illustrated in FIG. 10. The filter coefficient table 50 illustrated in FIG. 8 stores a filter coefficient value K_{j,i} to be multiplied by the j-th filter tap Pj for the i-th wavelength candidate Li of the target wavelength. The filter coefficient table 50 is used in an example in which the reference wavelength is fixed. The filter taps illustrated in FIG. 10 are only examples. It is a matter of course that more or less filter taps may be used or filter taps with different pixel positions may be used. The configuration of the filter taps may differ depending on the target wavelength.

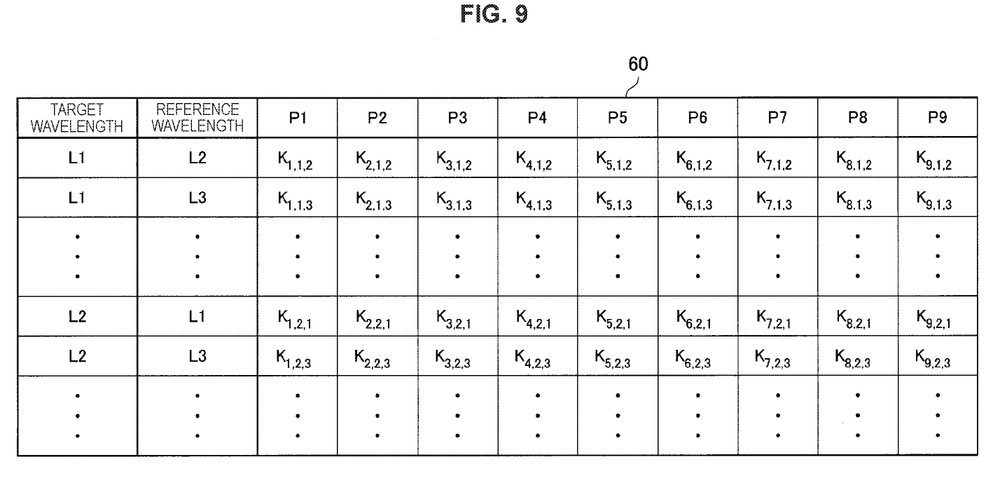

FIG. 9 is an explanatory diagram illustrating a specific example of a filter coefficient table for a filter coefficient determined in advance for each of combinations of the plurality of wavelength candidates and reference wavelengths. The example in FIG. 9 is also on the basis of the assumption that the filter for converting the pixel values are formed of spatial filter taps P1 to P9 with a 3×3 grid shape around a focused pixel P5 as illustrated in FIG. 10. The filter coefficient table 60 illustrated in FIG. 9 stores a filter coefficient value K_{j,i,k} to be multiplied by the j-th filter tap Pj for the i-th wavelength candidate Li and the k-th wavelength candidate Lk (i≠k) of the target wavelength. The filter coefficient table 60 is used in an example in which the reference wavelength is variable.

The filter coefficients illustrated in FIGS. 8 and 9 may be determined in advance through learning processing, for example. In prior learning for determining the filter coefficients, a large number of pairs of infrared images for a plurality of wavelength candidates of the target wavelength and corresponding teacher images are prepared. The corresponding teacher images described herein may be images adjusted in advance to have gradation levels that are similar to a gradation level of an infrared image obtained when the same object is imaged at the reference wavelength (the teacher images may be the infrared image itself with the reference wavelength). Then, the filter coefficients for converting the gradation levels of the respective infrared images to the level similar to that of the infrared image with the reference wavelength are determined in accordance with an existing algorithm such as boosting or a support vector machine.

Furthermore, the storage unit 156 may store the infrared image acquired by the acquisition unit 154 or the infrared image with the pixel values converted by the conversion unit 158.

### (Conversion Unit)

The conversion unit 158 converts the pixel values of the infrared image by using conversion control information that depends on the target wavelength. For example, the conversion control information includes a set of filter coefficients. Then, the conversion unit 158 converts the pixel values of the infrared image by performing filter computation on the infrared image by using the filter coefficients acquired from the storage unit 156.

Specifically, the conversion unit 158 performs the filter computation by constructing the filter taps as exemplified in FIG. 19 for the respective focused pixels of the infrared image and applying the filter coefficients stored in the filter coefficient table 50 or the filter coefficient table 60 to the filter taps. For example, when the target wavelength is L3 in an example in which the reference wavelength is fixed, the conversion unit 158 can use the filter coefficients K_{1,3} to K_{9,3} illustrated in the filter coefficient table 50 for the filter computation. When the target wavelength and the reference wavelength are L2 and L1, respectively, in an example in which the reference wavelength is variable, the conversion unit 158 can use the filter coefficients K_{1,2,1} to K_{9,2,1} illustrated in the filter coefficient table 60 for the filter computation.

The conversion unit 158 outputs the infrared image in which the pixel values have been converted as a result of the filter computation to the control unit 152 and the storage unit 156. When the target wavelength is equal to the reference wavelength, the conversion unit 158 does not convert the pixel values of the infrared image. In such a case, the conversion unit 158 can directly output the infrared image input from the acquisition unit 154 to the control unit 152 and the storage unit 156. The conversion unit 158 may convert pixel values of only a part of the infrared image. For example, the conversion unit 158 may stabilize gradation in a specific region, to which the user is to pay attention, in the infrared image (a living body region where a pedestrian is imaged or an object region where another vehicle or the like is imaged, for example) by converting pixel values only in the specific region.

### 2-3. OPERATIONS

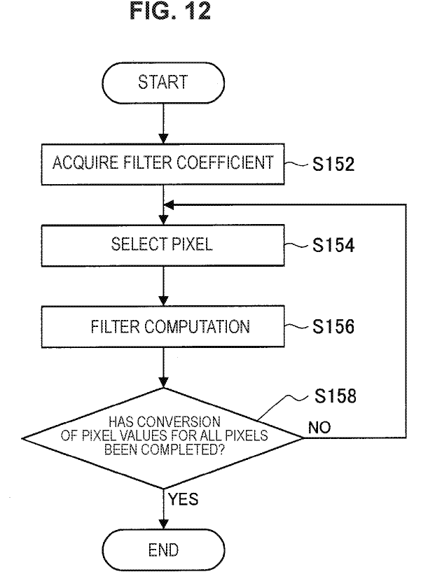

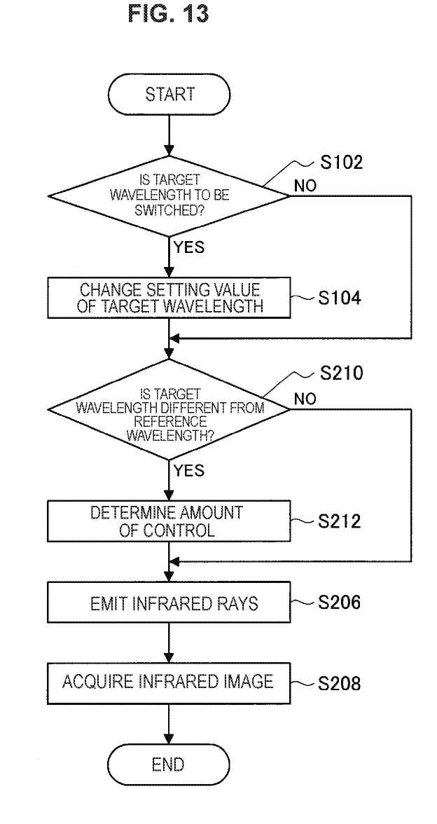

Next, a flow of processing performed by the image processing device 1 according to the embodiment of the present disclosure will be described with reference to FIGS. 11 and 12.

FIG. 11 is a flowchart illustrating a specific example of a flow of processing performed by the image processing device 1 according to the embodiment of the present disclosure. As illustrated in FIG. 11, the control unit 152 determines whether or not the target wavelength set at the timing is to be switched to another wavelength (Step S102) first. If it is determined that the target wavelength is to be switched (Step S102/YES), the control unit 152 changes a setting value of the target wavelength (Step S104). For example, the control unit 152 may switch the passing band of the optical filter of the infrared camera 102 or may change the setting of the wavelength components to be separated by the acquisition unit 154. In contrast, if it is not determined that the wavelength is to be switched (Step S102/NO), Step S104 is skipped. Next, the control unit 152 causes the infrared camera 102 to emit an infrared ray in an irradiation band including the target wavelength (Step S106). Then, the acquisition unit 154 acquires an infrared image with the target wavelength (Step S108) and outputs the infrared image to the conversion unit 158. Next, the control unit 152 determines whether or not the target wavelength is different from the reference wavelength (Step S110). If it is determined that the target wavelength is not different from the reference wavelength (Step S110/NO), the conversion unit 158 outputs the infrared image acquired by the acquisition unit 154 to the control unit 152 and the storage unit 156 without converting the pixel values of the infrared image. In contrast, if it is determined that the target wavelength is different from the reference wavelength (Step S110/YES), the conversion unit 158 performs pixel value conversion processing (Step S112). Then, the conversion unit 158 outputs the infrared image in which a change in gradation due to the change in the target wavelength has been lessened to the control unit 152 and the storage unit 156. Thereafter, the aforementioned processing is repeated on the next frame.

FIG. 12 is a flowchart illustrating a specific example of a flow of the pixel value conversion processing executed in Step S112 in FIG. 11. As illustrated in FIG. 12, the conversion unit 158 acquires a set of filter coefficients corresponding to the setting value of the target wavelength at the timing (and, if necessary, the setting value of the reference wavelength) from the storage unit 156 first (Step S152). Next, the conversion unit 158 selects one pixel in the infrared image as a focused pixel (Step S154) and performs the filter computation on the focused pixel by using the filter coefficients (Step S156). Then, if pixels for which the pixel value conversion has not been completed remain (Step S158/NO), the conversion unit 158 selects the next pixel as a focused pixel and repeats the aforementioned processing thereon. In contrast, if the pixel value conversion has been completed on all the pixels (Step S158/YES), the pixel value conversion processing ends.

According to the aforementioned embodiment, the control unit 152 variably controls the target wavelength of the infrared image acquired by the acquisition unit 154 so as to be different from wavelengths of infrared rays emitted in the vicinity. This suppresses the infrared rays emitted from other infrared cameras from being captured in the obtained infrared image. According to the image processing device 1 of the embodiment of the present disclosure, the control unit 152 controls the gradation of the infrared image depending on the target wavelength. This makes it possible to represent more stable infrared images to the user or to output the more stable infrared image to processing in a later stage without being affected by disturbance such as switching of the target wavelength.

According to the aforementioned embodiment, the control unit 152 controls the gradation of the infrared image so as to lessen the change in the gradation of the infrared image from the image acquired at the reference wavelength when the target wavelength is different from the reference wavelength. This can suppress an adverse effect on visual recognition of an object by the user or person or object recognition in the following recognition processing, which is brought by an unexpected change in the gradation before and after the switching of the target wavelength.

According to a certain embodiment, the control unit 152 controls the gradation of the infrared image by causing the conversion unit 158 to convert the pixel values of the infrared image by using the conversion control information depending on the target wavelength. Therefore, even when there is an unexpected change in the gradation of the infrared images obtained before and after the switching of the target wavelength, it is possible to reduce the change after the image acquisition. According to such a method of converting the pixel values, it is possible to implement the mechanism for controlling the gradation at relatively low cost since there is no need for optically or mechanically controlling the imaging module to control the gradation.

In a certain example, the conversion unit 158 converts the pixel values of the infrared image by performing the filter computation in the infrared image by using the filter coefficients determined in advance through learning processing. Therefore, it is possible to provide a plausible infrared image with less distortion in the image content due to the control of the gradation after the conversion.

In a certain example, the conversion unit 158 uses the filter coefficients determined in advance for the plurality of respective wavelength candidates in the filter computation. This enables the conversion unit 158 to more rapidly acquire the filter coefficients when the target wavelength is switched, as compared with a method of dynamically calculating the conversion control information. Therefore, it is possible for the conversion unit 158 to convert the pixel values with less delay.

In a certain example, the conversion unit 158 uses the filter coefficients determined in advance for each of the combinations of the plurality of wavelength candidates and the reference wavelengths in the filter computation. This enables the conversion unit 158 to more rapidly acquire appropriate filter coefficients and convert the pixel values of the infrared image even when not only the target wavelength but also the reference wavelength is dynamically switched, thereby providing a plausible infrared image after the conversion.

### 2-4. MODIFICATION EXAMPLES

Some modification examples of the aforementioned embodiment will be described in this section.

### First Modification Example

The first modification example is a modification example related to a method of controlling gradation of an infrared image. In the first modification example, the conversion unit 158 can be omitted from the configuration of the image processing device 1.

In the first modification example, the control unit 152 controls gradation of an infrared image by controlling the amount of an infrared ray received at the infrared camera depending on the target wavelength. Specifically, when the target wavelength is switched, the control unit 152 determines the amount of control of the infrared camera 102 on the basis of the target wavelength of the setting value after the change and causes the infrared camera 102 to image an object on the basis of the determined amount of control. For example, the amount of control of the infrared camera 102 determined by the control unknit 152 may be the amount of adjustment of exposure time of the infrared camera 102 or of the intensity of the infrared ray emitted by the infrared camera 102. Such an amount of control can be determined in advance for each of the candidates of the target wavelength (or each of the combinations between the candidates of the target wavelength and the reference wavelengths) so as to lessen the change in the gradation of the infrared image, and can be stored in the storage unit 156. The acquisition unit 143 outputs the acquired infrared image to the control unit 152 and the storage unit 156.

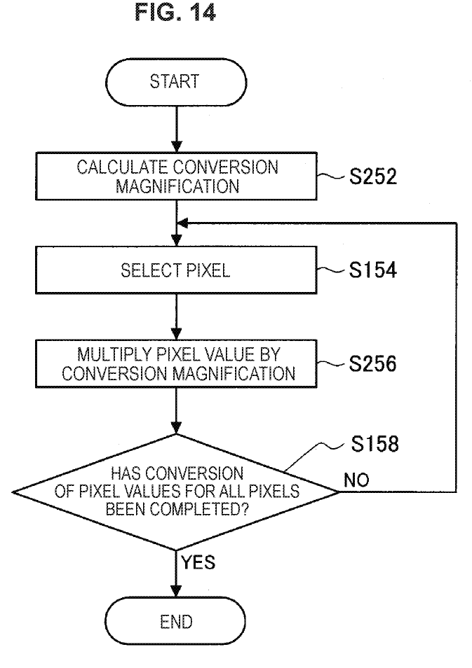

Hereinafter, a flow of processing performed by the image processing device 1 according to the first modification example will be described with reference to FIG. 13.

FIG. 13 is a flowchart illustrating a specific example of a flow of processing performed by the image processing device 1 according to the first modification example. As illustrated in FIG. 13, the control unit 152 determines whether or not the target wavelength set at that timing is to be switched to another wavelength first (Step S102). If it is determined that the target wavelength is to be switched (Step S102/YES), the control unit 152 changes the setting value of the target wavelength (Step S104). In contrast, if it is not determined that the target wavelength is to be switched (Step S102/NO), Step S104 is skipped. Next, the control unit 152 determines whether or not the target wavelength is different from the reference wavelength (Step S210). If it is determined that the target wavelength is different from the reference wavelength (Step S210/YES), the control unit 152 determines the amount of control of the infrared camera 102 depending on the target wavelength (or a combination of the target wavelength and the reference wavelength) (Step S212). In contrast, if it is determined that the target wavelength is not different from the reference wavelength (Step S210/NO), Step S212 is skipped. Next, the control unit 152 causes the infrared camera 102 to emit the infrared ray in accordance with the amount of control determined in Step S212 (Step S206), if necessary, and causes the acquisition unit 154 to acquire the infrared image through image capturing by the infrared camera 102 (Step S208). Then, the acquisition unit 154 outputs the acquired infrared image to the control unit 152 and the storage unit 156. Thereafter, the aforementioned processing is repeated on the next frame.

According to the first modification example, the control unit 152 controls the gradation of the infrared image by controlling the amount of infrared ray received at the imaging unit depending on the target wavelength as described above. Therefore, it is possible to reduce the change in the gradation before and after the switching of the target wavelength of the infrared ray used for image capturing by the infrared camera without requiring later conversion of the pixel values.

### Second Modification Example

The example in which the pixel values of the infrared image were converted by the filter computation using the filter coefficients was described in the previous section. In the second modification example, the respective pixel values of an infrared image are converted by a simpler method.

In the second modification example, the conversion control information depending on the target wavelength includes a single conversion magnification that is commonly applied to a plurality of pixels, and the conversion unit 158 converts the respective pixel values of the infrared image by multiplying the respective pixel values of the infrared image by the conversion magnification. For example, the conversion unit 158 calculates the conversion magnification on the basis of a ratio of gradation averages before and after the switching of the target wavelength. Instead, the conversion magnification may be determined in advance for each of the candidates of the target wavelength (or each of the combinations of the candidates of the target wavelength and the reference wavelength).

Hereinafter, a flow of processing performed by the image processing device 1 according to the second modification example will be described. The flow of the processing performed by the image processing device 1 according to the second modification example is different from the flow of the processing described above with reference to FIG. 11 in the pixel value conversion processing (Step S112). Hereinafter, a flow of the pixel value conversion processing performed by the image processing device 1 according to the second modification example will be described with reference to FIG. 14.

FIG. 14 is a flowchart illustrating a specific example of the flow of the pixel value conversion processing according to the second modification example. As illustrated in FIG. 14, the conversion unit 158 calculates the conversion magnification first by calculating a ratio between a gradation average of the image before the switching of the target wavelength (or the image captured at the reference wavelength in the past) and a gradation average of the image after the switching, for example (Step S252). Next, the conversion unit 158 selects one pixel in the infrared image as a focused pixel (Step S154) and calculates a pixel value of the focused pixel after conversion by multiplying the pixel value of the focused pixel by the conversion magnification (S256). Then, if pixels for which pixel value conversion has not been completed remain (Step S158/NO), the conversion unit 158 selects the next pixel as a focused pixel and repeats the aforementioned processing thereon. In contrast, if the pixel value conversion has been completed for all the pixels (Step S158/YES), the pixel value conversion processing ends.

According to the second modification example, the conversion control information includes a single conversion magnification to be commonly applied to a plurality of pixels, and the conversion unit 158 converts the respective pixel values of the infrared image by multiplying the respective pixel values of the infrared image by the conversion magnification as described above. Therefore, it is possible to simply control the gradation of the infrared image without requiring complicated processing such as preliminary learning processing or filter computation using a large number of filter taps. Furthermore, since it is not necessary to store the filter coefficients with a relatively large amount of information in advance, the memory can be saved.

### 3. CONCLUSION

According to the embodiment of the present disclosure, it is possible to provide stable infrared images that are not affected by disturbance while suppressing infrared rays emitted from other infrared cameras from being captured in the infrared images as described above.

The series of control processes carried out by each apparatus described in the present specification may be realized by software, hardware, or a combination of software and hardware. Programs that compose such software may be stored in advance for example on a storage medium (non-transitory medium) provided inside or outside each of the apparatus. As one example, during execution by a computer, such programs are written into RAM (Random Access Memory) and executed by a processor such as a CPU.

Note that it is not necessary for the processing described in this specification with reference to the flowchart to be executed in the order shown in the flowchart. Some processing steps may be performed in parallel. Further, some of additional steps can be adopted, or some processing steps can be omitted.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.
(1)

An image processing device including:

an acquisition unit that acquires an infrared image; and

a control unit that variably controls a target wavelength of the infrared image acquired by the acquisition unit and controls gradation of the infrared image depending on the target wavelength.
(2)

The image processing device according to (1),

wherein the control unit controls the gradation of the infrared image to lessen a change in the gradation of the infrared image from an image acquired at a reference wavelength when the target wavelength is different from the reference wavelength.
(3)

The image processing device according to (2), further including:

a conversion unit that converts pixel values of the infrared image acquired by the acquisition unit,

wherein the control unit controls the gradation of the infrared image by causing the conversion unit to convert the pixel values of the infrared image by using conversion control information depending on the target wavelength.
(4)

The image processing device according to (3),

wherein the conversion control information includes a filter coefficient, and

the conversion unit converts the pixel values of the infrared image acquired by the acquisition unit by performing filter computation on the infrared image using the filter coefficient.
(5)

The image processing device according to (4),

wherein the conversion unit performs the filter computation using the filter coefficient determined in advance through learning processing.
(6)

The image processing device according to (3),

wherein the conversion control information includes a single conversion magnification that is commonly applied to a plurality of pixels, and

the conversion unit converts each of the pixel values of the infrared image acquired by the acquisition unit by multiplying each of the pixel values of the infrared image by the conversion magnification.
(7)

The image processing device according to any one of (3) to (6),

wherein the control unit selects the target wavelength from a plurality of wavelength candidates, and

the image processing device further includes a storage unit that stores the conversion control information determined in advance for each of the plurality of wavelength candidates.
(8)

The image processing device according to (7),

wherein the storage unit stores the conversion control information for each of combinations of the plurality of wavelength candidates and the reference wavelength.
(9)

The image processing device according to (2), further including: an imaging unit that images an object by receiving infrared rays,

wherein the acquisition unit acquires, as the infrared image, an original image obtained by the imaging, and

the control unit controls the gradation of the infrared image by controlling the amount of the received infrared rays at the imaging unit depending on the target wavelength.
(10)

The image processing device according to any one of (1) to (9), further including:

an imaging unit that images an object by receiving infrared rays that have passed through an optical filter,

wherein the acquisition unit acquires, as the infrared image, an original image obtained by the imaging, and

the control unit variably controls the target wavelength of the infrared image acquired by the acquisition unit by switching a passing band of the optical filter.
(11)

The image processing device according to any one of (1) to (8),

wherein the acquisition unit acquires the infrared image by separating a component of the target wavelength from an original image obtained by imaging an object.
(12)

An image processing method including:

acquiring an infrared image by an image processing device;

variably controlling a target wavelength of the acquired infrared image; and

controlling gradation of the infrared image depending on the target wavelength.
(13)

A program causing a computer that controls an image processing device to function as:

an acquisition unit that acquires an infrared image; and

a control unit that variably controls a target wavelength of the infrared image acquired by the acquisition unit and controls gradation of the infrared image depending on the target wavelength.

### REFERENCE SIGNS LIST

1 image processing device
102 infrared camera
104 input interface
106 memory
108 display
110 communication interface
112 storage
114 processor
116 bus
152 control unit
154 acquisition unit
156 storage unit
158 conversion unit

1. An image processing device comprising:
an acquisition unit that acquires an infrared image; and
a control unit that variably controls a target wavelength of the infrared image acquired by the acquisition unit and controls gradation of the infrared image depending on the target wavelength.

2. The image processing device according to claim 1,
wherein the control unit controls the gradation of the infrared image to lessen a change in the gradation of the infrared image from an image acquired at a reference wavelength when the target wavelength is different from the reference wavelength.

3. The image processing device according to claim 2, further comprising:
a conversion unit that converts pixel values of the infrared image acquired by the acquisition unit,
wherein the control unit controls the gradation of the infrared image by causing the conversion unit to convert the pixel values of the infrared image by using conversion control information depending on the target wavelength.

4. The image processing device according to claim 3,
wherein the conversion control information includes a filter coefficient, and
the conversion unit converts the pixel values of the infrared image acquired by the acquisition unit by performing filter computation on the infrared image using the filter coefficient.

5. The image processing device according to claim 4,
wherein the conversion unit performs the filter computation using the filter coefficient determined in advance through learning processing.

6. The image processing device according to claim 3,
wherein the conversion control information includes a single conversion magnification that is commonly applied to a plurality of pixels, and
the conversion unit converts each of the pixel values of the infrared image acquired by the acquisition unit by multiplying each of the pixel values of the infrared image by the conversion magnification.

7. The image processing device according to claim 3,
wherein the control unit selects the target wavelength from a plurality of wavelength candidates, and
the image processing device further includes a storage unit that stores the conversion control information determined in advance for each of the plurality of wavelength candidates.

8. The image processing device according to claim 7,
wherein the storage unit stores the conversion control information for each of combinations of the plurality of wavelength candidates and the reference wavelength.

9. The image processing device according to claim 2, further comprising:
an imaging unit that images an object by receiving infrared rays,
wherein the acquisition unit acquires, as the infrared image, an original image obtained by the imaging, and
the control unit controls the gradation of the infrared image by controlling the amount of the received infrared rays at the imaging unit depending on the target wavelength.

10. The image processing device according to claim 1, further comprising:
an imaging unit that images an object by receiving infrared rays that have passed through an optical filter,
wherein the acquisition unit acquires, as the infrared image, an original image obtained by the imaging, and
the control unit variably controls the target wavelength of the infrared image acquired by the acquisition unit by switching a passing band of the optical filter.

11. The image processing device according to claim 1,
wherein the acquisition unit acquires the infrared image by separating a component of the target wavelength from an original image obtained by imaging an object.

12. An image processing method comprising:
acquiring an infrared image by an image processing device;
variably controlling a target wavelength of the acquired infrared image; and
controlling gradation of the infrared image depending on the target wavelength.

13. A program causing a computer that controls an image processing device to function as:
an acquisition unit that acquires an infrared image; and
a control unit that variably controls a target wavelength of the infrared image acquired by the acquisition unit and controls gradation of the infrared image depending on the target wavelength.
